(19) United States
(12) Patent Application Publication
(10) Pub. No.: US 2008/0033115 A1
(43) Pub. Date: Feb. 7, 2008

(54) Block copolymers of diallyldialkylammonium derivatives

(76) Inventors: Balint Koroskenyi, Peekskill, NY (US); William J. Peer, Patterson, NY (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/881,722

(22) Filed: Jul. 27, 2007

Related U.S. Application Data
(60) Provisional application No. 60/835,216, filed on Aug. 3, 2006.
(60) Provisional application No. 60/932,391, filed on May 31, 2007.

(51) Int. Cl. C08F 10/00; C08C 19/22

(52) U.S. Cl. 525/340; 525/353; 525/360; 525/375; 525/539

(57) ABSTRACT

The invention encompasses novel amphiphilic block copolymers comprising a hydrophobic block and a hydrophilic block wherein the hydrophilic block is formed from diallyldialkylammonium salt and the hydrophobic block comprises a polyolefin. Furthermore, convenient methods of preparing the amphiphilic block copolymers are disclosed. The amphiphilic block copolymer may be used to increase the wettability and printability of a plastic surface. The amphiphilic block copolymer may also be melt blended with a thermoplastic to form an anti-statically finished polymeric.

This application takes the benefit of U.S. Provisional Application Nos. 60/835,216, filed Aug. 3, 2006 and 60/932,391, filed May 31, 2007.

### FIELD OF THE INVENTION

Novel amphiphilic block copolymers and methods of making are disclosed comprising a hydrophobic block and a hydrophilic block wherein the hydrophilic block comprises a diallyldialkylammonium salt monomer unit and the hydrophobic block comprises a polyolefin. Also disclosed are various uses of said amphiphilic block copolymer such as an antistat and an agent for altering the surface properties of polymeric surfaces.

### BACKGROUND

The present invention is directed to a new amphiphilic block copolymers formed from a diallydialkylammononium block and a polyolefin block.

Amphiphilic block copolymers comprising an hydrophobic block and a hydrophilic block are well known in the art. Furthermore, amphiphilic block copolymers derived from a cationic block and a neutral hydrophobic block are also known.

U.S. Pat. No. 6,579,947 describes an hydraulic fracturing fluid contain a block copolymer wherein one of the blocks may be formed from cationic monomers. U.S. Publication Nos. 2006/0205827, 2003/0219397, 2006/0258756, 2004/0202634, 2004/0039101, 2005/0053569, and U.S. Pat. No. 7,105,579 also describe amphiphilic block copolymers which may contain cationic monomers.

U.S. Pat. No. 6,413,306 discloses a pigment dispersion containing an ABC block polymer. The B block may be formed from quaternized alkylamino alkyl(meth)acrylate monomers.

U.S. Pat. No. 6,559,233 describes aqueous compositions comprising block copolymers of at least two anionic blocks or at least two cationic blocks, and at least one non-ionic block.

U.S. Pat. No. 6,437,040 discloses water soluble block copolymer comprising an hydrophilic block and an hydrophobic block wherein the hydrophobic block also contains hydrophilic units in an amount between 33% to 99% by weight with respect to the total weight of the units of the hydrophobic block. The disclosed block copolymer is used as a wetting agent or an adhesion promoter.

Block copolymers formed from an hydrocarbon block and a cationic block are specifically known. For example, JP 3481733 discloses amphiphilic block copolymers containing a cationic block formed from a monomer containing a quaternary ammonium and a hydrophobic block comprising an polyolefin block. The block copolymer may be used as an antistat in polyolefin resins. U.S. Pat. No. 6,552,131 describes a block polymer containing a hydrophobic block from a polyolefin and a cationic block. Furthermore, GB 1,169,017 discloses a copolymer with polyolefinic and cationic blocks.

U.S. Pat. No. 7,196,142 describes a block copolymer comprising polyisbutylene and poly (2-dimethylamino)ethyl methacryate. The poly (2-dimethylamino)ethyl methacrylate is quaternized after the block copolymer is synthesized to form a cationic block copolymer.

Block copolymers incorporating diallydialkylammonium salts are known. For example, several literature articles describe block copolymer comprising a polyethylene glycol block and a polydiallydialkylammonoium block. See Tirelli, N. et al, Macromol. Chem. Phys., 200, 1068-1073 and Lieske, A. et al., Macromol. Chem. Phys., 199, 255-260 (1998).

Tal'Rose, R. et al., Macromol. Rapid Commun. 19, 517-522, (1998) discloses a block copolymer of polydiallydimethylammonium chloride and cetyl acrylate.

Although, multiple amphiphilic block copolymers have been described in the literature, there still exists a need for new amphiphilic block copolymers which combine blocks of very different properties and methods for synthesizing such amphiphilic block copolymers.

### SUMMARY OF THE INVENTION

The present invention encompasses several compositional and method embodiments:

The compositional embodiments are:

An amphiphilic block copolymer;

An antistatic agent comprising said amphiphilic block copolymer;

An anti-statically finished polymeric article comprising a melt blend of said amphiphilic block copolymer and a thermoplastic resin;

The method embodiments are:

A method of preparing said amphiphilic block copolymer;

and

A method for increasing the wettability, printability or anti-static properties of a plastic surface.

The amphiphilic block copolymer is a block copolymer comprising at least an A polymer block and a B polymer block, wherein block A is a hydrophilic polymer comprising the monomer unit defined by formula (I)

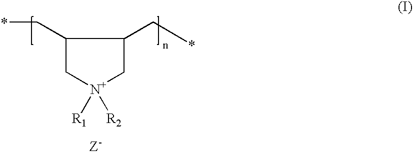

wherein R₁ and R₂ are independently branched or unbranched C₁ to C₂₂alkyl, aryl, benzyl or hydroxyalkyl, Z⁻ is any counterion and n is 2, 3, 4 or greater,

and

block B is a hydrophobic polymer comprising a polyolefin.

The method for preparing the amphiphilic block copolymer above comprising the steps of polymerizing a cationic monomer or a potentially cationic monomer in the presence of

a hydrophobic B block polymer, which hydrophobic B block is terminated with a functional group or chain transfer group.

The method of increasing the wettability, printability or anti-static properties of a plastic surface comprises the steps of melt blending the amphiphilic block copolymer with a thermoplastic substrate polymer.

### DETAILED DESCRIPTION OF THE INVENTION

“Block copolymers” as used herein is meant to encompass two or more different polymeric units which are linked to form a single polymer molecule. Typically, the block copolymers are in the form of di-, tri- and multi-block polymers. For example, the block copolymer may comprise a diblock copolymer such as Block A-Block B or a triblock copolymer such as Block A-Block B-Block A or Block B-Block A-Block B. An AB-AB architecture is also possible.

Thus, it is a further aspect of the present invention to provide an amphiphilic block copolymer comprising a polyolefin block connected to a hydrophilic block comprising the repeat unit of formula (I) or to provide an amphiphilic block copolymer comprising a plurality of hydrophilic blocks comprising the repeat unit of formula (I) connected to a polyolefin block.

A block may be defined by naming a polymer or by naming monomers it is derived from.

For purposes of the invention, a monomer unit is defined as the unit formed after polymerization. For example, the monomer unit of formula (I) is the repeat unit making up at least some part of the hydrophilic block A. The terms repeat unit or monomer unit are used synonymously.

The term monomer by itself refers to the monomer before polymerization.

A block may be a copolymer, comprising several kinds of repeating units or monomer units, deriving from several monomers. Block A and block B are different polymers, deriving from different monomers, but they may comprise some common repeating units or monomer units (copolymers).

The block copolymers may be linear, grafted, comb, crosslinked or star architecture.

A linear architecture would normally exclude crosslinked structures.

A star architecture generally requires a core radiating at least three functional groups. The functional groups of the core may be reacted to form a covalent bond with either block A or Block B. The formed arms containing block A or B are then further reacted to incorporate an alternating AB or BA structure depending upon which block forms the first sequence radiating off the core.

For purposes of the invention the term “polymer block” refers to one of the blocks of the block copolymer (either the hydrophilic block or the hydrophobic block).

Amphiphilic block copolymers are normally defined as block copolymers comprising hydrophobic and hydrophilic blocks or segments.

In the block copolymer of the invention, block A is hydrophilic and block B is hydrophobic. Hydrophilic or hydrophobic properties of a block refer to the property said block would have without the other block(s), that is the property of a polymer consisting of the same repeating units as said block and having the same average molecular weight.

The terms “hydrophobic” and “hydrophilic,” when applied to the block copolymers of this invention, are used in their ordinary sense. That is, hydrophilic, when it refers to a polymer, means that the polymer has a strong tendency to bond with or absorb water, which can result in solution of the polymer or swelling and/or formation of a gel. This property is characteristic of polymers prepared from polar or ionic monomers. Similarly, hydrophobic, when it refers to hydrophobic block, means that the polymer is antagonistic to water and generally cannot be dissolved in or swelled by water. This property is characteristic of polymers prepared from relatively non-polar monomers.

The formed amphiphilic block copolymer, may be soluble or dispersible in water. The amphiphilic block copolymer may for example be dispersible therein. The amphiphilic block copolymer may form micelles.

### Hydrophilic Block A

In regard to formula (1), C₁-C₂₂ alkyl means C₁-C₂₂ alkyl is linear or branched and is, for example, C₁-C₁₈, C₁-C₁₆, C₁-C₁₂, C₁-C₈, C₁-C₆, or preferably C₁-C₄-alkyl. Alternatively, C₁-C₂₂ alkyl may be C₄-C₂₂, C₆-C₂₂, C₈-C₂₂, C₁₀-C₂₂ or C₁₂-C₂₂. Examples are methyl, ethyl, propyl, isopropyl, n-butyl, sec-butyl, isobutyl, tert-butyl, pentyl, hexyl, heptyl, 2,4,4-trimethylpentyl, 2-ethylhexyl, octyl, nonyl, decyl, undecyl, dodecyl, tetradecyl, pentadecyl, hexadecyl, heptadecyl octadecyl, lauryl, stearyl, cetyl, behenyl or mixtures thereof. C₈-C₂₂ alkyl is for example, 2,4,4-trimethylpentyl, 2-ethylhexyl, octyl, nonyl, decyl, undecyl, dodecyl, tetradecyl, pentadecyl, hexadecyl, heptadecyl octadecyl, lauryl, stearyl, cetyl, behenyl or mixtures thereof.

Hydroxy alkyl is for example C₁-C₄ hydroxyalkyl such as hydroxymethyl, hydroxyethyl, hydroxypropyl or hydroxybutyl.

Aryl is for example substituted or unsubstitued phenyl. The phenyl ring may be substituted by halogen or C₁-C₄ alkyl.

Z⁻ may be a anion, represented by but not limited to chloride, bromide, iodide, floride substituted or unsubstituted aryl sulfonates, sulfate, alkyl sulfonates such as methyl sulfonate, ethyl sulfonate, carboxylates, nitrate, phosphates, tetrafluoroborate, tetraalkylborate, tetraarylborate, perchlorate, and hexafluorophosphate.

Super strong acid anions such as BF₄⁻, PF₆⁻, SbF₆⁻, AsF₆⁻, TIF₆⁻, BF₃Cl⁻, PF₅Cl⁻, SbF₅Cl⁻, AsF₅Cl⁻, TIF₅Cl⁻, BF₃Br⁻, PF₅Br⁻, SbF₅Br⁻, AsF₅Br⁻, TlF₅Br⁻, BF₃I⁻, PF₅I⁻, SbF₅I⁻, AsF₅I⁻ and TIF₅I⁻ confer heat resistance to the quaternary ammonium groups of the block copolymer. Thus for example, when Z⁻ is selected from the group of anions consisting of BF₄⁻, PF₆⁻, BF₃Cl⁻ and PF₅Cl⁻ the heat stability of the amphiphilic block copolymer of the invention improves.

The method of introducing a super strong acid anion as a counterion to the cationic group may be accomplished by treating an aqueous dispersion of the chloride of polydiallydimethyl ammonium with 0.025 M sodium tetrafluoroborate solution, followed by washing with water and concentrating.

Substituted aryl sulfonates for example are p-toluenesulfonate.

The n of formula (I) represents at least 2 monomer units, preferably n will represent greater than 3 or 4 monomer units. There is no particular upper limit to n and will depend on the characteristics of the desired amphiphilic block copolymer but will normally not exceed 5000. Representative ranges of numbers of monomer units or repeat units may be 2 to about 4000, 2 to about 3000, 2 to about 2000 or 2 to about 500 monomer units. The ammonium polymer blocks may be any molecular weight. The preferred average molecular weight however will vary from about 200 g/mole to about 1,000,000 g/mole, about 200 g/mole to about 500,000 g/mole, about 200 g/mole to about 50,000 g/mole, and more preferably from about 200 g/mole to 100,000 g/mole, for example, about 200 g/mole to about 10,000 g/mole, about 200 to about 5,000 or about 200 to about 3000 or about.

The monomer unit of formula (I) may be formed for example from a cationic monomer of formula (II) or a potentially cationic monomer of formula (III) as below.

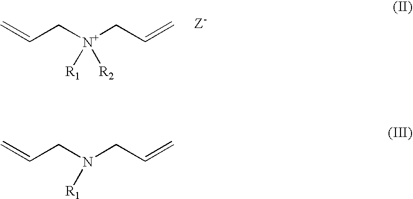

wherein, R₁ , R₂ and Z⁻ are defined as above in formula (I).

For example, the cationic group of monomers may be selected from the group consisting of diallyidimethylammonium chloride, diallyldimethylammonium bromide, diallyldimethylammonium sulfate, diallydimethylammonium phosphate, diallyldi(beta-hydroxyethyl)ammonium chloride and diallylmethylbenzylammonium chloride.

It is also possible to form the monomer unit of formula (I) by taking the corresponding amine such as diallyalkylamine, polymerizing then quaternizing with typical alkylating agents to arrive at the monomer unit described by formula (I).

Quaternization is typically done via an alkylating agent such as benzyl chloride, methyl iodide, ethyl iodide and benzyl iodide.

While the hydrophilic A must contain a monomer unit of formula (I), the hydrophilic block may also contain additional cationic, potentially cationic, anionic, potentially anionic, nonionic, zwitterionic monomer units or mixtures thereof.

Thus the hydrophilic block A for example may be a homopolymer or copolymer.

Preferable, the hydrophilic block A of the amphiphilic block copolymer will carry a cationic charge. For example, the hydrophilic block will comprise the monomer unit of formula (I) and nonionic monomer units or the hydrophilic A block will contain monomer units of formula (I) and anionic monomers units wherein the monomer units of formula (I) exceed the anionic monomer units. Additional combinations for the hydrophilic block A polymer might be monomer units of formula (I) and zwitterionic monomer units.

Cationic monomer units may be formed from potentially cationic monomers or cationic monomers. For example, additional cationic monomers or potentially cationic monomers may be protonated or quaternized N,N-dialkylaminoalkyl (meth)acrylate or protonated or quaternized N,N-dialkylaminoalkyl (meth)acrylamide, protonated or quaternized N,N-dialkylaminoalkyl maleimide or protonated or quaternized vinyl pyridine.

For purposes of the invention (meth)acrylate includes acrylate and methacrylate derivatives.

Representative examples can be selected from the group consisting of suitable cationically charged or potentially cationically charged monomers including dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, dimethylaminoethyl acrylate, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacrylate, diethylaminoethyl acrylate, diethylaminoethyl acrylate methyl chloride quaternary salt, diethylaminoethyl methacrylate, diethylaminoethyl methacrylate methyl chloride quaternary salt, methacrylamidopropyltrimethylammonium chloride, acrylamidopropyltrimethylammonium chloride, dimethylaminopropylacrylamide methyl sulfate quaternary salt, dimethylaminopropylacrylamide sulfuric acid salt, dimethylaminopropylacrylamide hydrochloric acid salt, dimethylaminopropylacrylamide, diallylamine and vinylpyridine.

The nonionic monomer units may be formed from nonionic monomer(s).

The nonionic monomer(s) are polymerizable allylic, vinylic compounds and are electrically neutral. Representative nonionic monomers include acrylamide, methacrylamide, N-methyl(meth)acrylamide, N,N-dimethyl(meth)acrylamide, N-isopropyl(meth)acrylamide, N-(2-hydroxypropyl)(meth)acrylamide, poly(ethylene glycol)(meth)acrylate, poly(ethylene glycol) monomethyl ether mono(meth)acrylate, N-methylolacrylamide, N-vinylformamide, N-vinylacetamide, N-vinyl-N-methylacetamide, fumaramide, N-vinyl-2-pyrrolidone, glycerol mono((meth)acrylate), 2-hydroxyethyl(meth)acrylate, vinyl methylsulfone, vinyl acetate, diacetone acrylamide, diesters of maleic, fumaric, succinic and itaconic acids.

Nonionic monomers may be macromers which contain vinylic or allylic functionality. Macromers may be defined as a polymer end functionalized with an allylic or vinylic functionality. For example, poly(ethylene glycol)(meth)acrylate, poly(ethylene glycol) monomethyl ether mono(meth)acrylate are macromers.

Thus the amphiphilic block copolymer may contain a hydrophilic block A which is a copolymer and additionally comprises alkylene glycol units.

Hydrophobic nonionic monomers may also be incorporated into the hydrophilic block A and include acrylates such as methyl (meth)acrylate, ethyl(meth)acrylate, hexyl(meth)acrylcate, hexyl(meth)acrylate, octyl(meth)acrylate, stearyl(meth)acrylate, stearyl ethoxy (meth)acrylate stearyl ethoxyallylether and mixtures thereof.

Although hydrophobic nonionic monomers may be included in the hydrophilic block A, the block A should still maintain is hydrophilic character. Thus the weight % of monomer unit of formula (I) will exceed the weight % of nonionic hydrophobic monomer units in the polymer block A. For example, the weight % of the hydrophobic nonionic monomers in the hydrophilic block A may range from about 0 to about 30 weight % of the total weight of polymer block A., about 1 to about 20 weight %, about 1 to about 10 weight % or about 1 to about 5 weight % of the total weight of polymer block A.

The anionic or potentially anionic monomer units are formed from anionic or potentially anionic monomer(s). The anionic or potentially anionic monomer(s) are derived from alpha ethylenically unsaturated monomers selected from the groups consisting of alpha ethylenically unsaturated monomers containing phosphate or phosphonate groups, alpha ethylenically unsaturated monocarboxylic acids, monoalkylesters of alpha ethylenically unsaturated dicarboxylic acids, monoalkylamides of alpha ethylenically unsaturated dicarboxylic acids, alpha ethylenically unsaturated compounds comprising a sulphonic acid group, salts of alpha ethylenically unsaturated compounds comprising a sulphonic acid group and mixtures thereof.

Representative examples of anionic or potentially anionic monomers include acrylic acid, methacrylic acid, vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid, 2-sulphoethyl methacrylate, salts of 2-sulphoethyl methacrylate, acrylamido-2-methylpropanesulphonic acid (AMPS), salts of acrylamido-2-methylpropanesulphonic acid, maleic acid, fumaric acid, itaconic acid, succinic acid, styrenesulphonate and its salts or mixtures thereof.

The zwitterionic monomer or monomers of (iv) are derived from ethylenically unsaturated monomer or monomers. A zwitterionic monomer for the purposes of the invention is defined as a monomer that contains both anionic and cationic charges or potential anionic and cationic charges.

Representative examples are

N,N-dimethyl-N-acryloyloxyethyl-N-(3-sulfopropyl)-ammonium betaine,

N,N-dimethyl-N-acryloyloxyethyl-N-(2-carboxymethyl)-ammonim betaine,

N,N-dimethyl-N-acrylamidopropyl-N-(3-sulfopropyl)-ammonium betaine,

N,N-dimethyl-N-acrylamidopropyl-N-(2-carboxymethyl)-ammonium betaine,

2-(methylthio)ethyl methacryloyl-S-(sulfopropyl)-sulfonium betaine,

2-[(2-acryloylethyl)dimethylammonio]ethyl 2-methyl phosphate,

2-(acryloyloxyethyl)-2′(trimethylammonim)ethyl phosphate,

[(2-acryloxylethyl)dimethylammonio]methyl phosphonic acid,

2-methacryloyloxyethyl phosphorylcholine (MPC),

2-[(3-acrylamidopropyl)dimethylammonio]ethyl 2′-isopropyl phosphate (AAPI),

1-vinyl-3-(3-sulfopropyl)imidazolium hydroxide,

(2-acryloxyethyl) carboxymethyl methylsulfonium chloride,

1-(3-sulfoproyl)-2-vinylpyridinium betaine,

N-(4-sulfobutyl)-N-methyl-N,N-diallylamine ammonium betaine (MDABS),

N,N-diallyl-N-methyl-N-(2-sulfoethyl) ammonium betaine or mixtures thereof.

The hydrophilic polymer block may be a homopolymer or random copolymer, block copolymer or a grafted polymer or copolymer.

### Hydrophobic Block B

Hydrophobic block B is formed from a polyolefin.

Polyolefins for purposes of the invention are formed from at least one monomer selected from the group consisting of ethylene, propylene, 1-butene, 2-methyl-1-butene, 2-butene, isobutylene, butadiene, isoprene, pentene, 4-methyl-1-pentene, 1-hexene, 1-octene, 1-decene, 1-octadecene, vinyl cyclohexene, cyclopentadiene, 0-pinene, styrene, alpha-methyl styrene, p-chlorostyrene, p-methyl styrene, vinyl chloride and mixtures thereof.

The hydrophobic polymer blocks may be any molecular weight. The preferred molecular weight however will vary from 200 g/mole to about 1,000,000 g/mole, about 200 g/mole to about 500,000 g/mole, about 200 g/mole to about 50,000 g/mole and more preferably from 200 g/mole to about 10,000 g/mole, or about 200 g/mole to about 5000 g/mole.

The hydrophobic polymer block may be a homopolymer or random copolymer, block copolymer or a grafted polymer or copolymer. Thus for example, the hydrophobic polymer block may be formed from a linear copolymer of ethylene and butylene.

The hydrophobic block B may also contain additional cationic, potentially cationic, anionic, potentially anionic, nonionic, zwitterionic monomer units or mixtures thereof.

These additional monomers are defined as above.

Although the hydrophobic block B may contain additional hydrophilic monomers, hydrophobic block B should maintain its hydrophobic properties. Thus the olefinic monomer units making up the hydrophobic block will exceed cationic, anionic, nonionic (different than the olefins listed above) or zwitterionic monomer units. For example, the weight % of hydrophilic nonionic monomers in the hydrophobic block B may range from about 0 to about 30 weight % of the total weight of polymer block B, about 1 to about 20 weight %, about 1 to about 10 weight % or about 1 to about 5 weight % of the total weight of polymer block B.

The hydrophobic block B will preferable be uncharged or neutral. For purposes of the invention this means that the hydrophobic block B will preferably be formed from ethylenically unsaturated monomers which are not charged such as cationic, anionic or zwitterionic monomers.

The hydrophobic polymer block may be a homopolymer or random copolymer, block copolymer or a grafted polymer or copolymer.

The polyolefin making up the hydrophobic block B may contain a terminal functional group or chain transfer agent.

For example, U.S. Pat. No. 6,552,131, herein incorporated entirely by reference, describes low molecular-weight polyolefins obtained by thermal degradation. The so obtained polyolefins contain, on an average, 1 to 1.5 terminal double bonds per molecule. These terminally unsaturated polyolefins may be modified to functionalize the unsaturated ends.

End functionalized polyolefins may be purchased directly from suppliers such as Scientific Polymer Products, Mitsui Chemicals, Baker Petrolite and Aldrich. For example, copolymers of ethylene and butylene, copolymers of ethylene, butylene and propylene and homopolymers of styrene which are mono or dihydroxy terminated are commercially available from Scientific Polymer Products in a range of average molecular weights (1,700-4,200). Polyethylene mono-ol is available from Baker Petrolite at Mₙ˜700. Poly (ethylene-co-1,2-butylene mono-ol is available from Aldrich, CAS no. 68954-09-6, Mₙ˜3750.

A thiol terminated hydrophobic block may be synthesized by treating for example, a hydrophobic resin having double bonds or hydroxyl groups at its terminals with such reagents as thioacetic acid, thiobenzoic acid, thiopropionic acid, thiobutyric acid, secondary alcohol or thiovaleric. The synthesis is well known to those skilled in the art, for example in Japanese Pat. No. 3481733 and Ying Jun Du et al. in J. Appli. Polym. Sci., 2003, 594.

The hydrophilic polymer block may be separately synthesized by any suitable polymerization process. The diallydialkylammonium polymers may be prepared for instance as gel polymers by solution polymerization, water-in-oil suspension polymerization or by water-in-oil emulsion polymerization. When preparing gel polymers by solution polymerization the initiators are generally introduced into the monomer solution.

The hydrophilic block polymers may be produced separately as beads by suspension polymerization or as a water-in-oil emulsion or dispersion by water-in oil emulsion polymerization, for example according to a process defined by EP150933, EP-102760 or EP-126528.

The hydrophilic block polymer may be synthesized by conventional radical polymerization or by controlled polymerizations.

The hydrophilic block and hydrophobic block may each be formed first, then covalently linked by reacting the terminal functional groups to form the final block copolymer.

Preferably, however the method for preparing an amphiphilic block copolymer described above

comprising the steps of polymerizing a cationic monomer or a potentially cationic monomer in the presence of
a hydrophobic B block polymer, which hydrophobic B block is terminated with a functional group or chain transfer group.

One of the advantages of the above method is the ability to directly polymerize a cationic monomer in the presence of the hydrophobic block polymer terminated with a chain transfer agent thus arriving at the charged amphiphilic block copolymer directly.

The inventors believe the formation of an amphiphilic block copolymer comprising a diallydialkyl ammonium salt block (hydrophilic) and a polyolefin (hydrophobic) block to be novel. It is not too surprising that such an amphiphilic block copolymer has never actually been made until now for several reasons. First of all, diallydialkyl ammonium salt does not polymerize readily when compared to other (meth)acrylates and secondly, formation of amphiphilic block polymers directly from the cationic salt is difficult because the reactants (a hydrophobic preformed block and the cationic salt monomer) have very different solubility characteristics.

It is of course, also possible to polymerize a potentially cationic monomer then subsequently charge by quaternization after polymerization to form the monomer unit of formula (I).

For example, a diallyldialkylammonium monomer is polymerized in the presence of a suitably terminated preformed B block. Preferably B block is terminated with a chain transfer group.

Suitably terminated with a chain transfer group for purposes of the invention means termination or pendant termination with a thiol, xanthate, dithioester, trithioester, dithiocarbamate, secondary alcohol or nitroxyl.

The block copolymer may then be directly formed by polymerizing the cationically charged vinyl monomer in the presence of for example, a thiol terminated hydrophobic block and initiator.

Thus the hydrophilic block A and hydrophobic block B for example, are then covalently linked via a sulfur atom to form the amphiphilic block copolymer.

When the chain transfer agent is sulfur, and the monomer is cationic, the resulting amphiphilic block copolymer is defined for example, by the formula (II) below.

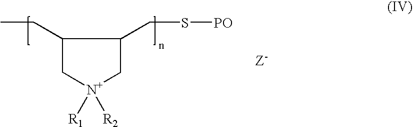

wherein R₁, R₂, n and Z⁻ are defined as in claim 1,

S is sulfur and

PO represents a polyolefin.

It is also possible that the hydrophobic block be grafted with pendent chain transfer groups such as thiols. The cationic monomer, for example diallyldialkylammonium salt, would then be polymerized in the presence of a hydrophobic polymer with thiol pendant groups, giving a grafted block copolymer.

Thus a hydrophobic block B might be grafted with a cationic block A to form a comb architecture amphiphilic block copolymer.

The polymerization may be initiated with an initiator such as those activated by heat, light or electromagnetic radiation.

Typical initiators are for example radical initiators such as azobis compounds such as azobisisobutyronitrile, azobis-2,4-dimethylvaleronitrile, azobiscyclohexane carbonitrile, azobis-2-amidinopropane hydrochloride, dimethyl azobisisobutyrate, azobisisobutylamidine hydrochloride and 4,4′-azobis-4-cyanovaleric acid, peroxide initiators such as benzoyl peroxide, benzoyl 2,4-dichloroperoxide, di-tert-butyl peroxide, lauroyl peroxide, acetyl peroxide, diisopropyl dicarbonate peroxide, cumene hydroperoxide, tert-butyl hydroperoxide, dicumyl peroxide, p-menthane hydroperoxide, pinane hydroperoxide, methyl ethyl ketone peroxide, cyclohexanone peroxide, diisopropyl peroxy dicarbonate, tert-butyl peroxy laurate, di-tert-butyl peroxy phthalate, dibenzyl oxide and 2,5-dimethylhexane-2,5-dihydroperoxide, and redox initiators such as benzoyl peroxide-N,N-dimethyl aniline, peroxodisulfuric acid-sodium hydrogen sulfite and salts of persulfate such as sodium, potassium or ammonium persulfate.

Photoinitiators are also envisioned.

The reaction solvent includes, for example, aliphatic hydrocarbons such as pentane, hexane, heptane, octane, decane, dodecane and tetradecane, alicyclic hydrocarbons such as cyclopentane, methylcyclopentane, cyclohexane, methylcyclohexane, cyclooctane and cyclohexene, aromatic hydrocarbons such as benzene, toluene and xylene, halogenated hydrocarbons such as dichloromethane, chloroform, dichloroethane, dichloropropane, trichloroethylene, chlorobenzene, dichlorobenzene and 2,4-dichlorotoluene, esters such as methyl acetate, ethyl acetate and butyl acetate, ketones such as acetone and methyl ethyl ketone, and dioxane, tetrahydrofuran, acetonitrile, dimethylformamide, dimethyl sulfoxide and alcohols such as, ethanol, propanol, n-butanol and sec-butanol.

The addition of surfactants to the solvents is also envisioned.

These can be used alone or as a mixture thereof. Mixtures of solvents may be preferable when the blocks are dissimilar. Such solvents preferably include C₂-C₆ alcohols, and/or N,N-dimethylformamide, dimethylsulfoxide, or N,N-dimethylacetamide, and may be combined with other solvents, such as toluene or tetrahydrofuran.

C₂-C₆ alcohols are for examples, n-propanol, n-butanol, sec-butanol, cyclopentanol, n-pentanol, hexanol and cyclohexanol.

The hydrophobic block will to a large extent determine the choice of solvent. For example, if the polyolefin (Block B) is polystyrene, N,N-dimethylformamide may be used to disperse the polystyrene block. The diallydialkylammonium salt monomer may be dispersed in a C₂-C₆ alcohol and then added to the dispersed polystyrene and polymerized to form the amphiphilic block copolymer.

If the reaction is run in a solvent system, it is important the solvent system allow good dispersion of both the hydrophobic block and the forming hydrophilic block. The particular solvent system will depend very much on the composition and molecular weight of each block and needs to be determined experimentally.

Water based systems incorporating a surfactant might also be used for synthesis of the block copolymer.

The formed amphiphilic block copolymer may be any average molecular weight depending upon the application. The average molecular weight will range from about 500 g/mole to about 1,000,000 g/mole, about 1000 g/mole to about 1,000,000 g/mole, about, about 500 g/mole to about 500,000 g/mole, about 1000 g/mole to about 80,000 g/mole, about 1000 g/mole to about 20,000 g/mole, about 100 g/mole to about 10,000 g/mole and about 100 g/mole to about 6,000 g/mole.

Uses of Amphiphilic Block Copolymer

The amphiphilic block copolymer of the invention may be used in applications such as rheology modifiers, emulsifiers, stabilizing agents of latexes, demulsifiers, solubilizing agents for hydrophobic dyes or pigments, pigment dispersants, cosmetic compositions, hard surface cleaners and antistats.

Furthermore, the amphiphilic block copolymers may be used to alter surface characteristics of substrates such as textiles, fabrics, nonwovens, and plastics. The surfaces of these substrate are often quite hydrophobic, especially when formed from plastics or polymeric materials. These plastic or polymeric materials build up static charges. Furthermore, the materials are difficult to print or wet. Incorporation of the amphiphilic block copolymer on or into the plastic or polymeric material serves to provide improved antistat, wetting and printing properties of the hydrophobic material.

For example, the amphiphilic block copolymer may be used to treat a plastic or polymeric material by dipping, coating or spraying thus improving the wettability, printability or anti-static characteristics of the surface.

An anti-statically finished polymeric article may be formed by melt blending the amphiphilic block copolymer with a thermoplastic. The polymeric article may be formed by calendering, extruding, spray coating, spinning, compression melting, rotational casting, thermoforming or extrusion blowing.

The anti-statically finished polymeric article may be a fiber, film, molded article or foamed article.

For example, incorporation of the amphiphilic block copolymer of the invention may be useful for packaging materials and housing products for household electrical appliances. The amphiphilic block copolymer may be melt blended for example, in computer housing.

The amphiphilic block copolymers may also be added during synthetic fiber production, for example as a melt additive during fiber formation.

Thus the invention embodies:

An anti-statically finished polymeric article comprising a melt blend of the amphiphilic block copolymer and a thermoplastic.

The amphiphilic block copolymers of the invention are salts and as such may not actual melt or partially melt depending upon the actual composition of the hydrophilic and hydrophobic block. The block copolymers are however at least dispersible in the thermoplastic matrix.

When the amphiphilic block copolymer is used as an antistat the average molecular weight will for example range from about 1000 g/mole to about 30,000 g/mole, about 1000 g/mole to about 8000 g/mole or 1000 g/mole to about 5000 g/mole.

Further, a method of increasing the wettability or printability of a plastic surface or improving the anti-stat characteristics of a plastic surface comprises the steps of melt blending the amphiphilic block copolymer with a thermoplastic substrate polymer.

Thermoplastics are for example vinyl resins such as polyolefin or polystyrene resins, rubber-like polymers such as ABS, acrylic resins, polyamide resins, polyesters, polyacetals, polycarbonates, thermoplastic polyurethanes and mixtures thereof.

Examples for Polyolefins are:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, for example polyethylene and polypropylene, can be prepared by different, and especially by the following, methods:

i) radical polymerization (normally under high pressure and at elevated temperature).

ii) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1.), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EM), LLDPE/EVA, LLDPE/EM and alternating or random polyalkylene/carbon monoxide copolymers and mixtures thereof with other polymers, for example polyamides.

Polyolefins of the present invention are for example polypropylene homo- and copolymers and polyethylene homo- and copolymers. For instance, polypropylene, high density polyethylene (HDPE), linear low density polyethylene (LLDPE) and polypropylene random and impact copolymers.

Examples of Polyesters are:

polymers derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN), for example polyethylene naphthalate and polyhydroxybenzoates, as well as block copolyether esters derived from hydroxyl-terminated polyethers; and also polyesters modified with polycarbonates or MBS.

The polyesters which may be used in the compositions of this invention include linear, thermoplastic, crystalline or amorphous polyesters produced by conventional polymerization techniques from one or more diols and one or more dicarboxylic acids. For instance, polyesters comprise at least about 50 mole percent terephthalic acid residues and at least about 50 mole percent ethylene glycol and/or 1,4-cyclohexanedimethanol residues.

The diol components of the described polyesters may be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X,8-bis(hydroxymethyl)-tricyclo-[5.2.1.0]-decane wherein X represents 3, 4, or 5; and diols containing one or more oxygen atoms in the chain e.g., diethylene glycol, triethylene glycol, dipropylene glycol, tripropylene glycol and the like. In general, these diols contain 2 to 18, for instance 2 to 8 carbon atoms. Cycloaliphatic diols can be employed in their cis or trans configuration or as mixtures of both forms.

The acid components (aliphatic, alicyclic, or aromatic dicarboxylic acids) of the linear polyester are selected, for example, from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalene-dicarboxylic acid and the like. In the polymer preparation, functional acid derivative thereof such as the dimethyl, diethyl, or dipropyl ester of the dicarboxylic acid are often employed. The anhydrides or acid halides of these acids also may be employed where practical.

The linear polyesters may be prepared according to procedures well known in the art. For example, a mixture of one or more dicarboxylic acids, for instance aromatic dicarboxylic acids, or ester forming derivatives thereof, and one or more diols may be heated in the presence of esterification and/or poly-esterification catalysts at temperatures in the range of 1500 to 300° C. and pressures of atmospheric to 0.2 mm Hg. Normally, the dicarboxylic acid or derivative thereof is esterified or transesterified with the diol(s) at atmospheric pressure and at a temperature at the lower end of the specified range. Polycondensation then is affected by increasing the temperature and lowering the pressure while excess diol is removed from the mixture. Solid state polymerization may be employed to achieve final polymer I.V. in a useful range for films and molded containers.

Examples of Polyamides are:

polymers and copolymers derived from diamines and dicarboxylic acids and/or from aminocarboxylic acids or the corresponding lactams, for example polyamide 4, poly-amide 6, polyamide 6,6, polyamide 6,10, polyamide 6,9, polyamide 6/12, polyamide 4,6, polyamide 12,12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

Polyamides included are those prepared by the polymerization of a monoamino-monocarboxylic acid or a lactam thereof having at least 2 carbon atoms between the amino and carboxylic acid group, of substantially equimolar proportions of a diamine which contains at least 2 carbon atoms between the amino groups and a dicarboxylic acid, or of a monoaminocarboxylic acid or a lactam thereof as defined above together with substantially equimolar proportions of a diamine and a dicarboxylic acid. The term “substantially equimolar” proportions includes both strictly equimolar proportions and slight departures therefrom which are involved in conventional techniques for stabilizing the viscosity of the resultant polyamides. The dicarboxylic acid may be used in the form of a functional derivative thereof, for example, an ester or acid chloride.

Examples of the aforementioned monoamino-monocarboxylic acids or lactams thereof which are useful in preparing the polyamides include those compounds containing from 2 to 16 carbon atoms between the amino and carboxylic acid groups, said carbon atoms forming a ring containing the —CO—NH— group in the case of a lactam. As particular examples of aminocarboxylic acids and lactams there may be mentioned ε-aminocaproic acid, butyrolactam, pivalolactam, ε-caprolactam, capryllactam, enantholactam, undecanolactam, dodecanolactam and 3- and 4-aminobenzoic acids.

Diamines suitable for use in the preparation of the polyamides include the straight chain and branched chain alkyl, aryl and alkaryl diamines. Illustrative diamines are trimethylenediamine, tetramethylenediamine, pentamethylenediamine, octamethylenediamine, hexamethylenediamine (which is often preferred), trimethylhexamethylenediamine, m-phenylenediamine and m-xylylenediamine.

The dicarboxylic acids may be represented by the formula

HOOC—B—COOH
wherein

B is a divalent aliphatic or aromatic group containing at least 2 carbon atoms. Examples of aliphatic acids are sebacic acid, octadecanedioic acid, suberic acid, glutaric acid, pimelic acid and adipic acid.

Both crystalline and amorphous polyamides may be employed, with the crystalline species often being preferred by reason of their solvent resistance. Typical examples of the polyamides or nylons, as these are often called, include, for example, polyamide-6 (polycaprolactam), 6,6 (polyhexamethylene adipamide), 11, 12, 4,6, 6,10 and 6,12 as well as polyamides from terephthalic acid and/or isophthalic acid and trimethylhexamethylenediamine; from adipic acid and m-xylylenediamines; from adipic acid, azelaic acid and 2,2-bis(p-aminophenyl)propane or 2,2-bis-(p-aminocyclohexyl)propane and from terephthalic acid and 4,4′-diaminodicyclohexylmethane. Mixtures and/or copolymers of two or more of the foregoing polyamides or prepolymers thereof, respectively, are also within the scope of the present invention. Preferred polyamides are polyamide-6, 4,6, 6,6, 6,9, 6,10, 6,12, 11 and 12, most preferably polyamide-6,6.

Examples of Polystyrenics are:

polystyrene, polyvinyltoluene and the like; copolymers of a styrene and at least one monomer selected from the group consisting of methyl methacrylate, acrylonitrile and butadiene, for example styrene-acrylonitrile copolymers (AS resins), acrylonitrile-butadiene-styrene copolymers (ABS resins), styrene-methyl methacrylate-acrylonitrile copolymers, methyl methacrylate-butadiene-styrene copolymers (MBS resins), styrene-butadiene copolymers and the like.

Examples of the Rubber-Like (Co)Polymers are:

polybutadiene, polyisoprene, polychloroprene, ethylene-propylene-butadiene copolymers, acrylonitrile-butadiene copolymers and the like.

Acrylic Resins are for Example:

(Co) polymers of more than one acrylic monomers such as C₁-C₂₀ alkyl (meth) acrylates, acrylonitrile as well as copolymers of more than one of these monomers and at least one copolymerizable vinyl monomer.

As the copolymerizable vinyl monomer, there may be monomers other than said acrylaic monomers, for example vinyl esters, dienes and halogen containing vinyl monomers.

Polyacetal Resins for Example are:

Homopolymers of formaldehyde or trioxane, for example polyoxymethylene homopolymers, and copolymers of formaldehyde or trioxane and a cyclic ether (the above-mentioned alkylene oxide, such as ethylene oxide or propylene oxide, or dioxolane), for example polyoxymethylene-polyoxyethylene copolymers.

Polycarbonate Resins are for Example:

Bisphenol skeleton-containing polycarbonates, for example condensates of bisphenol A and phosgene and condensates of bisphenol A and carbonate diester.

Thermoplastic Polyurethane Resins are for Example:

Derived from a diisocyanate with a high-molecular diol, polyester diol and/or polyether diol.

The amphiphilic block copolymer may be melt blended with the thermoplastic resin, wherein the amphiphilic block copolymer may make up about 0.1 wt. % to about 25 wt. %, about 1.0 to about 20 wt. %, or about 1.0 to about 10 wt. % of the anti-statically finished polymeric article.

Melt blending for purposes of the invention means that the thermoplastic resin and block copolymers may be fused and kneaded using fusion kneading machines such as monoaxial extruders, biaxial extruder, Brabenders, kneaders and Banbury's mixers, which are commonly used for mixing of resin materials.

The melt blended thermoplastic with amphiphilic block copolymer may be hot melt molded and heat processed and various types of molded products can be manufactured smoothly by injection molding, extrusion molding, inflation film molding and blow molding.

### EXAMPLES

### Example 1a

Thiol functionalized ethylene oligomer

A mixture of 10 g of vinyl end-functional ethylene oligomer (F-140, Mitsui Chemicals, average molecular weight is 1400), 700 mg AIBN, 20 mL toluene and 1.0 mL mercaptoacetic acid is stirred at 80° C. under N₂ for 4.5 h. The mixture is then allowed to cool and poured into methanol. The precipitate is filtered, rinsed with methanol and dried in vacuum. The product is combined with 40 mL toluene and 5 mL 10% methanolic NaOH and refluxed for 5 h. It is then poured into methanol, filtered and dried in vacuum.

### Example 1b

A thiol functionalized poly(ethylene-co-butylene)

Poly(ethylene-co-butylene) mono -ol (Scientific Polymer Products, 55 g, average molecular weight is 3800) is dissolved in 80 mL toluene. Mercaptoacetic acid (3.0 mL) and 2 drops of cc. sulfuric acid are added. The mixture is sparged with nitrogen for 30 min, then refluxed for 2 h. The product is precipitated with methanol, redissolved in toluene, precipitated again, rinsed with methanol 3 times and dried in vacuum.

### Example 2a

Thiol end-functional polystyrene

A mixture of 25.80 g hydroxyl end-functional polystyrene (Scientific Polymer Products, MW˜4000-5000), 40 mL toluene, 1.37 mL mercaptoacetic acid, and 1 drop sulfuric acid (1+1) is sparged for 30 min, and then refluxed for 2 h. The mixture is cooled in an ice bath and poured into methanol. The precipitate is filtered, rinsed with methanol and dried in vacuum.

### Example 2b

Thiol end-functional polystyrene

A 100 mL flask is charged with 25 g phenyl ether, 25 ml styrene, 10.2 g 2,2′-bipyridyl, 3.12 g copper(l) bromide, and 1.9 ml allyl bromide. The mixture is sparged for 30 min, and then heated at 100° C. for 5 h under nitrogen. The product is precipitated with methanol, redissolved in THF and passed through basic alumina. The solution is concentrated, precipitated with methanol, and the residual solvent is removed under vacuum.

The product is dissolved in 50 ml toluene, and 3.0 ml thioacetic acid and 2.05 g azobisisobutyronitrile are added. The mixture is sparged with nitrogen for 45 minutes, and heated at 80° C. for 5 h. The product is precipitated with methanol and the residual solvent is removed under vacuum.

The product (average molecular weight is˜1400) is dissolved in 120 ml toluene, and 2 ml saturated solution of sodium hydroxide in methanol is added. The mixture is stirred and continuously sparged with nitrogen for 6 h. It is then precipitated with methanol, and the residual solvent is removed under vacuum.

### Example 3a

Block copolymer of ethylene-co-butylene and diallyidimethylammonium chloride The thiol end functionalized poly(ethylene-co-butylene) of Example 1 b (22.5 g) is dissolved in 56 mL toluene and added to a solution of 45 g diallyldimethylammonium chloride in 56 mL n-butanol. 2,2′-Azobis(2-amidinopropane) dihydrochloride initiator (1.125 g) is added, and the mixture is sparged with nitrogen for 3 h. It is then stirred at 70° C. for 48 h. It is allowed to cool, precipitated with acetone, filtered and dried in vacuum. The product is treated with 1000 mL tetrahydrofuran and centrifuged. The solid is collected, rinsed with tetrahydrofuran and dried in vacuum.

### Example 3b

Block copolymer of ethylene-co-butylene and diallyldimethylammonium chloride A 500 mL flask is charged with an 32.5 g of diallyldimethylammonium chloride aqueous solution (77.5 wt. %). After the monomer has dissolved, a solution of 25 g thiol end functionalized poly(ethylene-co-butylene) of Example 1b in 125 mL toluene is added, followed by 125 mL n-butanol and 1.25 g 2,2′-azobis(2-amidinopropane) dihydrochloride initiator. The mixture is sparged with nitrogen for 45 min, then stirred at 70° C. for 24 h. The mixture is then poured into acetone, filtered, and dried in vacuum.

### Example 4a

Block copolymer of styrene and diallyldimethylammonium chloride The thiol end functionalized polystyrene of Example 2a (1.0 g) is dissolved in 2.0 mL toluene. To this is added a solution of 1.0 g diallyldimethylammonium chloride in 4.0 mL n-butanol and 51 mg 2,2′-azobis(2-amidinopropane) dihydrochloride initiator. The mixture is sparged with nitrogen for 30 min, and then stirred at 70° C. for 24 h. After 24 h, the mixture is cooled in an ice bath and precipitated with acetone. The precipitate is filtered, rinsed with acetone and dried in vacuum.

### Example 4b

Block copolymer of styrene and diallyldimethylammonium chloride

To a stirred solution of 2 g of the thiol functional polystyrene of Example 2b above in 10 ml dimethylformamide is added slowly a dispersion of 4 g dried diallyldimethylammonium chloride in 10 ml n-butanol. 320 mg 2,2′-azobis(2-amidinopropane) dihydrochloride initiator is added, and the mixture is sparged with nitrogen for 30 min, followed by stirring at 70° C. for 24 h. The solvent is removed under vacuum.

### Example 5

Melt Blending of Block Copolymer of Example 4A in Polystyrene

In order to evaluate the surface properties and anti-static properties of the compound of example 4b as additive for plastic, the following procedure is used:

A polystyrene powder [STYRON 484 from Dow] is dried in a vacuum oven for eight hours at 80° C. An appropriate amount of the compound of example 4a is dried in a vacuum oven for eight hours at 60° C. The formulations are mixed and extruded in a twin-screw extruder (MINILAB extruder from ThermoFisher Scientific) equipped with a flat die. In this way, tapes are produced with a width of 5 mm and a thickness of around 0.5 mm. The processing temperature is around 200° C. All produced tapes have a milky visual appearance.

The contact angle CA of the produced tapes are measured with a DATAPHYSICS OCA 30 contact angle device, using the sessile drop method and water as measuring liquid. After storage at room temperature, in 50% relative humidity (r.h.) and 15% r.h. for one week, the surface resistance SR (ohm/sq) of the sample is measured using a spring reed electrode in accordance with DIN 53482.

### Example 6

Processing of injection molded plaques containing the compounds of example 4b in Polystyrene

In order to evaluate the surface properties and anti-static properties of the compound of example 4b as additive, the following procedure is used:

A polystyrene powder [STYRON 484 from Dow] is dried in a vacuum oven for eight hours at 80° C. An appropriate amount of the compound of example 4b is added to the dried polystyrene powder. The formulations are mixed in a turbo mixer and compounded to pellets in a twin-screw extruder (MINILAB from ThermoFisher Scientific) and further injection molded to plaques of a width of 30 mm, length of 40 mm and thickness of 2 mm using a micro-injection molding machine (BABYPLAST from CronoPlast). The processing temperature is around 200° C. All produced plaques have a milky visual appearance.

The contact angles of the produced plaques are measured with a DATAPHYSICS OCA 30 contact angle device, using the sessile drop method and water as measuring liquid. After storage at room temperature, in 50% relative humidity (r.h.) and 15% r.h. for one week, the surface resistance SR (ohm/sq) of the sample is measured using a spring reed electrode in accordance with DIN 53482.

### Example 7 and 8

Processing of extrusion tapes or injection molded plaques containing the compound of example 4b in Polypropylene

Polypropylene: HC 115 MO from Borealis

Drying: 80° C.

Processing: 220° C.

1. An amphiphilic block copolymer comprising at least an A polymer block and a B polymer block, wherein block A is a hydrophilic polymer comprising the monomer unit of formula (I) 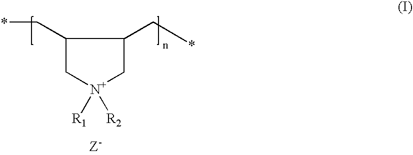
wherein R₁ and R₂ are independently branched or unbranched C₁ to C₂₂alkyl, aryl, benzyl or hydroxyethyl, Z⁻ is any counterion and n is 2 or more
and
block B is a hydrophobic polymer comprising a polyolefin.

2. The amphiphilic block copolymer according to claim 1, wherein R₁ and R₂ of formula (I) are independently C₁-C₆ alkyl or benzyl.

3. The amphiphilic block copolymer according to claim 1, wherein Z⁻ is selected from the group consisting of Cl⁻, Br⁻, I⁻, F⁻ substituted or unsubstituted aryl sulfonates, sulfate, alkyl sulfonates, carboxylates, nitrate, PO₄⁻, tetrafluoroborate, tetraalkylborate, tetraarylborate, ClO₄⁻, PF₆⁻, SbF₆⁻, AsF₆⁻, TIF₆⁻, BF₃Cl⁻, PF₅Cl⁻, SbF₅Cl⁻, AsF₅Cl⁻, TIF₅Cl⁻, BF₃Br⁻, PF₅Br⁻, SbF₅Br⁻, AsF₅Br⁻, TlF₅Br⁻, BF₃I⁻, PF₅I⁻, SbF₅I⁻, AsF₅I⁻ and TIF₅I⁻.

4. A amphiphilic block copolymer according to claim 1, wherein the polyolefin is formed from at least one monomer selected from the group consisting of ethylene, propylene, 1-butene, 2-methyl-1-butene, 2-butene, isobutylene, butadiene, isoprene, pentene, 4-methyl-1-pentene, 1-hexene, 1-octene, 1-decene, 1-octadecene, vinyl cyclohexene, cyclopentadiene, β-pinene, styrene, alpha-methyl styrene, p-chlorostyrene, p-methyl styrene, vinyl chloride and mixtures thereof.

5. The amphiphilic block copolymer according to claim 1, wherein the average molecular weight of the hydrophilic block A is about 200 g/mole to about 500,000 g/mole.

6. The amphiphilic block copolymer according to claim 1, wherein the average molecular weight of the hydrophobic block B is about 200 g/mole to about 500,000 g/mole.

7. The amphiphilic block copolymer according to claim 1, wherein the block B is uncharged or neutral.

8. The amphiphilic block copolymer according to claim 1, wherein the block copolymer is a linear, comb, star or grafted block copolymer.

9. The amphiphilic block copolymer according to claim 1, wherein the block copolymer is linear A-B or A-B-A architecture.

10. The amphiphilic block copolymer according to claim 1, wherein the hydrophilic block is a copolymer and the hydrophilic block additionally comprises nonionic units.

11. The amphiphilic block copolymer according to claim 10, wherein the nonionic units are poly(ethylene glycol)(meth)acrylate or poly(ethylene glycol) monomethyl ether mono(meth)acrylate

12. The amphiphilic block copolymer according to claim 1, wherein the hydrophilic block A and hydrophobic block B are covalently linked via a sulfur atom.

13. The amphiphilic block copolymer according to claim 1, wherein the amphiphilic block copolymer is defined by formula (IV) 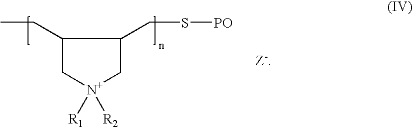
wherein R₁, R₂, n and Z⁻ are defined as in claim 1,
S is sulfur and
PO represents a polyolefin.

14. An anti-statically finished polymeric article comprising a melt blend of the amphiphilic block copolymer according to claim 1 and a thermoplastic.

15. A method for preparing an amphiphilic block copolymer according to claim 1,
comprising the steps of
polymerizing a cationic monomer or a potentially cationic monomer in the presence of an hydrophobic B block polymer, which hydrophobic B block is terminated with a functional group or chain transfer group.

16. The method according to claim 15, wherein the monomer being polymerized is cationic.

17. The method according to claim 15, wherein the chain transfer terminated hydrophobic B block is
formed by treating an hydroxyl terminated B block polymer with thioacetic acid, thiobenzoic acid, thiopropionic acid, thiobutyric acid or thiovaleric acid.

18. A method of increasing the wettability and/or printability of a polymer surface by melt blending the amphiphilic block copolymer of claim 1 with a thermoplastic resin.

19. A method of anti-statically finishing a polymeric article by melt blending the amphiphilic block copolymer of claim 1 with a thermoplastic resin.

20. A method of improving the anti-static characteristics of a polymeric material by dipping, coating or spraying the surface of said polymeric material with an amphiphilic block copolymer according to claim 1.
